(19) United States
(12) Patent Application Publication
(10) Pub. No.: US 2007/0286122 A1
(43) Pub. Date: Dec. 13, 2007

(54) Clear channel assessment threshold adaptation in a wireless network

(75) Inventor: Benedito J. Fonseca, Glen Ellyn, IL (US)

Correspondence Address: LAW OFFICES OF CHARLES W. BETHARDS, LLP, P.O. BOX 1622, COLLEYVILLE, TX, 76034, US

(73) Assignee: Motorola, Inc.

(21) Appl. No.: 11/451,277

(22) Filed: Jun. 12, 2006

(51) Int. Cl. H04L 12/56; H04Q 7/00

(52) U.S. Cl. 370/329; 370/400

(57) ABSTRACT

Methods (300) and corresponding systems (100) for adapting a clear channel assessment (CCA) threshold in a node in a wireless network includes determining a first successful transmission rate of the node and neighboring nodes in the wireless network when the node is set to use a first CCA threshold. Next, a second successful transmission rate of the node and the neighboring nodes is determined when the node is set to use a second CCA threshold. Thereafter, one of the first and the second CCA thresholds is selected based upon the first and second successful transmission rates. The determining a successful transmission rate of the node and neighboring nodes can include counting successful packet indications transmitted by the node and received by the node from the neighboring nodes. Transmitted successful packet indications can include transmitted acknowledgement messages.

### FIELD OF THE INVENTION

This invention relates in general to data communication, and more specifically to techniques and apparatus for selecting a clear channel assessment threshold in a node in a wireless data communication network.

### BACKGROUND OF THE INVENTION

A mobile ad hoc network (MANET) is a wireless communication network that does not have infrastructure and central coordination for controlling and scheduling the transmission of data packets between nodes in the network. A MANET is self-organizing and self-configuring to support both direct (e.g., node-to-node) and multi-hop communications. Such MANETs can be important to military applications and public safety applications where an infrastructure is unavailable. MANET technology can also enable new commercial applications.

Transmission scheduling algorithms are important in MANETs in order to manage channel contention and to improve channel reuse in a fair, decentralized manner. In some low cost networks, wireless devices, or nodes, use a single half-duplex transceiver that operates on a single radio channel. A collision occurs when two nodes transmit at the same time, possibly causing the corruption of both transmissions, with neither transmission being received at the intended receiver. Each node, which is not synchronized for transmission, can employ Carrier Sense Multiple Access/Collision Avoidance (CSMA/CA) techniques and procedures to access the channel. Some of these channel access procedures are set forth in the IEEE 802.11 set of wireless local area network (LAN/WLAN) standards developed by the Institute of Electrical and Electronics Engineers.

Before a node in a MANET decides to transmit data, the node generally performs a “clear channel assessment,” which can compare a received energy level (and sometimes test the ability to detect a direct spread spectrum sequence) with a threshold value, referred to herein as a “CCA threshold.” If the received energy exceeds the CCA threshold, the node declares the channel busy and waits for the duration of the current transmission before transmitting on the channel.

Within each node in the network, the decision of whether, or when, to transmit is important for achieving a higher level of efficiency in the overall packet transmission rate of the wireless network. If a node determines, for example, that the channel is busy when it is not, the node will not transmit its own data when it has the opportunity to successfully send the data. On the other hand, if the node determines that the channel is not busy when it is, the node will transmit data and corrupt the transmission of other nodes, corrupt its own transmission, wherein all corrupted transmissions must be resent, further reducing the overall data throughput of the network.

### BRIEF DESCRIPTION OF THE DRAWINGS

The accompanying figures, wherein like reference numerals refer to identical or functionally similar elements throughout the separate views and which together with the detailed description below are incorporated in and form part of the specification, serve to further illustrate various embodiments and to explain various principles and advantages, all in accordance with the present invention.

FIG. 1 depicts, in a simplified and representative form, a high-level block diagram of a wireless communication network having a plurality of wireless devices in accordance with one or more embodiments;

FIG. 2 is a simplified and representative diagram that shows a wireless network and an effect of changing a clear channel assessment threshold in a wireless device in accordance with one or more embodiments;

FIG. 3 is a high-level flowchart of processes executed by a wireless device that can be used in conjunction with the FIG. 1 communications system in accordance with one or more embodiments; and

FIG. 4 depicts a representation of a table stored in memory in a wireless device in accordance with one or more embodiments.

### DETAILED DESCRIPTION

In overview, the present disclosure concerns distributed scheduling algorithms for transmitting data in a wireless data communication network, such as a wireless communication network according to the IEEE 802.11 standard for mobile ad hoc networks (MANETs), which uses a Carrier Sense Multiple Access/Collision Avoidance (CSMA/CA) procedure or similar procedures to access the wireless channel. More particularly various inventive concepts and principles embodied in methods and apparatus may be used for automatically selecting and adapting a clear channel assessment (CCA) threshold used in a CSMA/CA procedure in a node in a MANET.

While the CCA threshold adaptation method and system of particular interest may vary widely, one embodiment may advantageously be used in a wireless communication system, or a wireless networking system, operating according to one or more respective standards. For example, one such wireless network standard is the IEEE 802.11b standard for wireless networking, published by the Institute of Electrical and Electronics Engineers (IEEE) and the American National Standards Institute (ANSI). Additionally, the inventive concepts and principles taught herein can be advantageously applied to other wireless communications systems, particularly where a plurality of wireless devices access a radio channel using multiple access and collision avoidance techniques.

The instant disclosure is provided to further explain, in an enabling fashion, the best modes, at the time of the application, of making and using various embodiments in accordance with the present invention. The disclosure is further offered to enhance an understanding and appreciation for the inventive principles and advantages thereof, rather than to limit the invention in any manner. The invention is defined solely by the appended claims, including any amendments made during the pendency of this application, and all equivalents of those claims as issued.

It is further understood that the use of relational terms, if any, such as first and second, top and bottom, and the like, are used solely to distinguish one entity or action from another without necessarily requiring or implying any actual such relationship or order between such entities or actions.

Much of the inventive functionality and many of the inventive principles can be implemented with, or in, integrated circuits (ICs), including possibly application specific ICs, or ICs with integrated processing controlled by embedded software, firmware, or program code. It is expected that one of ordinary skill—notwithstanding possibly significant effort and many design choices motivated by, for example, available time, current technology, and economic considerations—when guided by the concepts and principles disclosed herein will be readily capable of generating such software instructions and programs and ICs with minimal experimentation. Therefore, in the interest of brevity and minimizing any risk of obscuring the principles and concepts according to the present invention, further discussion of such software and ICs, if any, will be limited to the essentials with respect to the principles and concepts of the various embodiments.

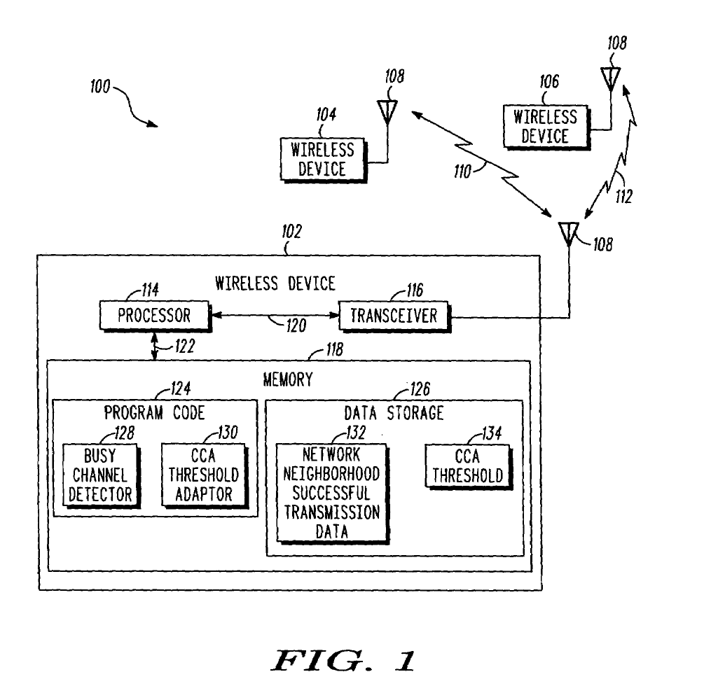

Referring now to FIG. 1, there is depicted, in a simplified and representative form, a high-level block diagram of wireless communication network 100, which includes a plurality of wireless devices 102, 104, and 106, in accordance with one or more embodiments. Wireless communication network 100 can be implemented in accordance with IEEE 802.11b (e.g., the Wi-Fi standard) or other standards and the like, wherein wireless devices 102, 104, and 106 cooperate in a mobile ad hoc network (MANET) to transmit and process data packets. Wireless devices 102, 104, and 106 can be referred to as nodes, which are devices that are connected as part of a computer or communication network. Wireless devices 102, 104, and 106 use antennas 108 to transmit and receive wireless signals via wireless channels 110 and 112.

Wireless communication network 100 is preferably a self-organizing and self-configuring, direct (node-two-node) and multi-hop communications network. Multi-hop communication is used when the radio channel separating two nodes is not suitable for direct communication, in which case one or more intermediary nodes relays a data packet until it reaches the final destination node.

Each wireless device 102, 104, and 106 typically includes a processor 114, which is coupled to transceiver 116 and memory 118. Processor 114 can perform many of the functions and operations that occur within wireless device 102 (and 104 and 106) by executing program code and using data stored in memory 118. In one embodiment, processor 114 can include one or more microprocessors, microcontrollers, or digital signal processors, which are each well known and readily available.

Processor 114 can be coupled to transceiver 116 through interface 120. In one embodiment, interface 120 can transfer data for transmission from transceiver 116, data received by transceiver 116, and various command and control signals. Transceiver 116, which is generally known and available, can include baseband logic and radio frequency circuits for encoding, modulating, and transmitting, and conversely receiving, demodulating, and decoding, signals that are transmitted and received using antenna 108. In one embodiment, transceiver 116 can communicate with other wireless devices using IEEE 802.11b protocol (e.g., Wi-Fi), or another similar protocol. Wireless device 102 can communicate wirelessly with other wireless devices 104 and 106 via wireless communication channels 110 and 112.

Processor 114 can be coupled to memory 118 through interface 122, which, in one embodiment, is configured to transfer data and program code for processing and execution in processor 114. In some embodiments, processor 114 can also include internal memory.

Memory 118 can be implemented using some combination of generally known memory technology, such as RAM, ROM, EPROM, magnetic, optical memory, and the like.

Memory 118 can include program code 124 and data storage 126, which are used to execute various algorithms, processes, and methods within processor 114 and wireless device 102. For example, program code 124 can include program code for processes and algorithms that implement busy channel detector 128 and CCA threshold adapter 130. As described in greater detail below, busy channel detector 128 can be used to detect whether another wireless device is transmitting on a channel used by transceiver 116, and CCA threshold adapter 130 can be used to adapt a clear channel assessment (CCA) threshold that is used in deciding whether transceiver 116 can transmit data without colliding with another transmission.

Data storage 126 can be used to store network neighborhood successful transmission data 132 and CCA threshold data 134. As described in greater detail below, network neighborhood successful transmission data 132 relates to the rate of successful transmissions of wireless device 102 and the network neighbors of wireless device 102. CCA threshold data 134 can be used to store a current best CCA threshold, and data related to the use of other CCA thresholds.

While much of the functionality of wireless devices 102, 104, and 106 can, in some embodiments, be attributed to software instructions as executed by processor 114, it will be appreciated that many of these operations can also be performed by hardware or some combination of software and hardware. Additionally, it will be appreciated by those of ordinary skill that a multiplicity of other functions or operations, which are not specifically shown, can be performed in a typical wireless device, and that various of those can be implemented, at least in part, with the processor(s) and various software instructions, etc.

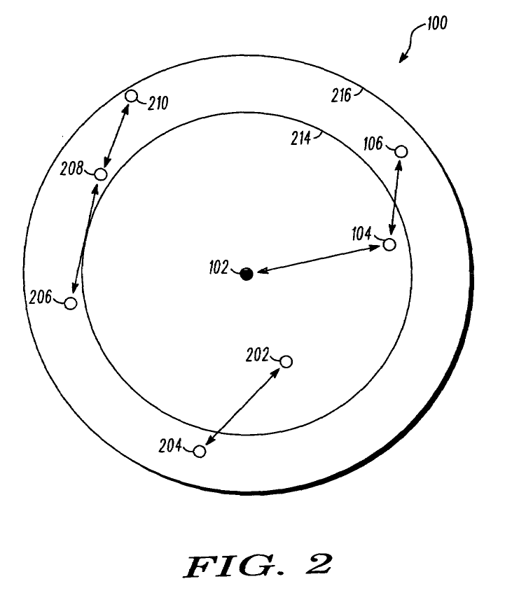

With reference now to FIG. 2, there is depicted a simplified and representative diagram that shows wireless network 100 and an effect of changing a CCA threshold in a wireless device in accordance with one or more embodiments. As shown, wireless device 102 is situated among other wireless devices, such as wireless devices 104 and 106, and wireless devices 202, 204, 206, 208, and 210. In a mobile ad hoc network (MANET), such wireless devices can self-organize and self-configure to form a data communication network. Communication in the MANET can be direct between two nodes, or indirect in the form of multi-hop communication that uses intermediary nodes to relay (hop) messages until they reach the final destination node. In a low cost MANET, all nodes can have a single, half-duplex transceiver, which means all nodes transmit or receive on a given radio channel, but they cannot do both simultaneously.

Furthermore, the nodes are typically not synchronized, which means that they can employ a Carrier Sense Multiple Access/Collision Avoidance (CSMA/CA) procedure to avoid transmitting while another nearby or neighbor node is transmitting, which can cause a collision wherein data reception at the receiving nodes can be corrupted by the interference between the two transmitting nodes.

A wireless device acting as a node in a wireless network can attempt to avoid collisions in the channel by listening for carrier signals from other wireless devices before beginning a transmission. If the wireless device senses the carrier signal, the wireless device delays its transmission until it no longer senses the carrier signal. In one embodiment, the wireless device determines whether a carrier signal is present by measuring radio frequency energy that exceeds a noise floor by a threshold, which is the CCA threshold. As the CCA threshold is lowered closer to the noise floor, the wireless devices become more sensitive to the transmission of other wireless devices, and will therefore determine not to transmit more often due to the greater range of sensing, which can include areas with more wireless devices.

For example, FIG. 2 shows how a change in a carrier sensing range is caused by changing a CCA threshold in wireless device 102. If the CCA threshold is set 1 dB above the noise floor, for example, the carrier sensing range is shown at 216. If the CCA threshold is set 2 dB above the noise floor, the carrier sensing range is shown at 214. Because the signal strength of transmissions from wireless devices can be closely correlated with distance from the receiver, changing the CCA threshold from 1 dB above the noise floor to 2 dB above the noise floor reduces the sensing range as shown by the change from 216 to 214.

A benefit of increasing the CCA threshold can come from the ability of wireless device 102 to ignore transmissions between wireless devices 206, 208, and 210, because these devices are now outside of range 214 used by wireless device 102 in determining whether the channel is clear for transmission. When wireless devices 206, 208, and 210 are outside carrier sensing range 214, wireless device 102 can transmit more often because it will not be waiting for the completion of transmissions by devices 206, 208, and 210.

A problem with increasing the CCA threshold, and correspondingly reducing the carrier sensing range from 216 to 214, is that wireless device 106 becomes a “hidden node” with respect to wireless device 102. Wireless device 106 becoming a hidden node with respect to wireless device 102, means that wireless device 102 does not sense or detect whether wireless device 106 is transmitting before beginning its own transmission. This means that wireless device 106 can be transmitting to wireless device 104 at a time when wireless device 102 begins transmitting to device 104, which creates a collision because wireless device 102 did not detect the transmission from “hidden” wireless device 106.

An “exposed node” problem exists when wireless device 102 senses wireless device 206 transmitting to wireless device 208 and then, in response, wireless device 102 delays its own transmission to wireless device 104, wherein the transmission from device 102 to device 104 can coexist without interference with the transmission from device 206 to device 208.

Thus, the “hidden node” problem erroneously fails to postpone a transmission that causes a collision, and the “exposed node” problem erroneously postpones a transmission that would not have caused a collision. Both of these problems should be avoided in order to increase data throughput in the wireless network. This means that it is important for each node to have the correct CCA threshold to increase proper access to the wireless channel and to increase the overall throughput of the wireless network. The correct CCA threshold for each node depends on several factors, including the particular relative placement of nodes and the propagation conditions among them.

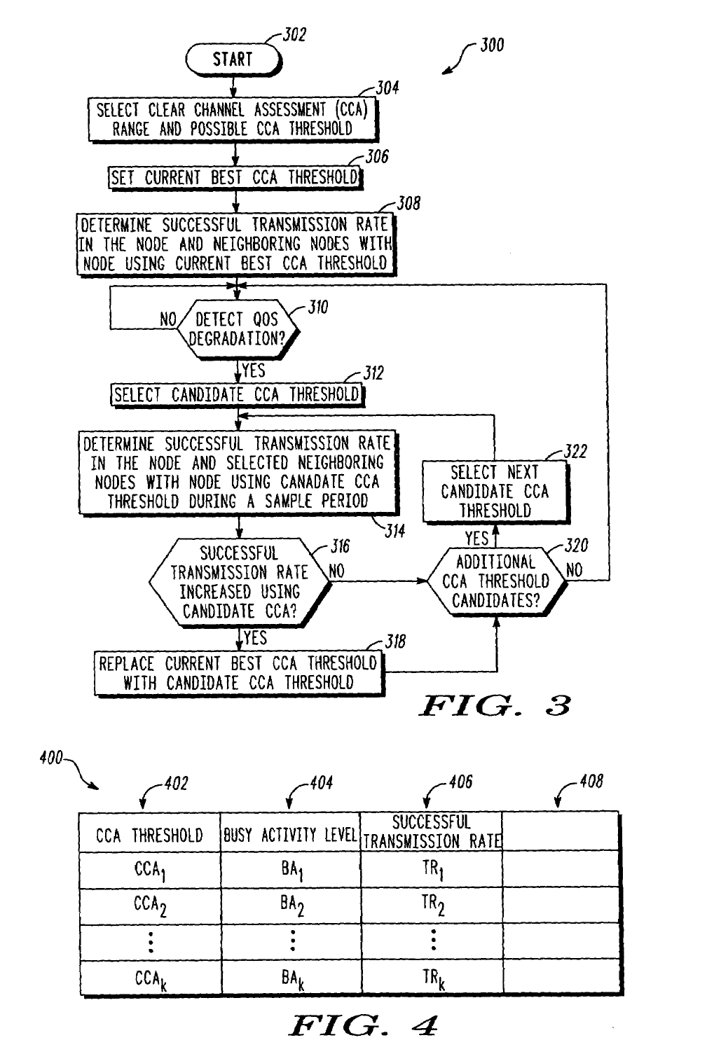

Turning now to the operation of one or more of the wireless devices in wireless communication network 100, FIG. 3 depicts a high-level flowchart 300 having exemplary processes executed by portions of a wireless device, such as wireless device 102, or executed by another similar apparatus, in accordance with one or more embodiments. As illustrated, the process begins at 302, and thereafter passes to 304 wherein the process selects a CCA range and a set of possible CCA thresholds that can be used within wireless device 102. Before determining a CCA threshold range, wireless device 102 can take measurements of the received signal strength level (RSSI) and determine the value of the noise floor, which can help set the lower limit of the CCA threshold. Note that the noise floor is the background level of radio frequency energy in the radio channel. The upper limit of the CCA threshold can be set by the standard, such as IEEE 802.11b.

In one embodiment, CCA thresholds can range from 1 dB to 9 dB above the noise floor, with several possible CCA thresholds within the range. For example, 2 to 8 possible levels can be used, where each level is spaced apart by, for example, 0.5 dB. Enough levels should be selected to fine tune the CCA threshold without having so many levels that it takes too long to test and determine the correct level.

Next, the process sets the current best CCA threshold to an initial CCA threshold, as shown at 306. In one embodiment, the initial CCA threshold can be near the middle of the range of thresholds. Alternatively, the initial CCA threshold can be set to a value that was stored before the wireless device was shut down after its previous use.

After setting the current best CCA threshold, the process determines a successful transmission rate in the node and in neighboring nodes with the node using the current best CCA threshold, as illustrated at 308. In one embodiment, the successful transmission rate in the node and in neighboring nodes can be determined by counting indications of successful packet transmissions for a period of time and then dividing by the period of time, wherein the indications of successful packet transmissions can be an “ACK” message (i.e., an acknowledgement message) that is transmitted by the node, or a neighboring node (i.e., the node and neighboring nodes collectively) to any other node. Thus, the node is collectively monitoring all indications of successful transmissions generated in its surroundings, including its own transmissions and transmissions not destined for the node, and then dividing by the time of the measurement, which may be hundreds of milliseconds. In order to be representative, the time required to collect indications of successful transmissions can be long enough to reduce the variance and the probability of error. In an alternative embodiment, the process can count packets indicating an unsuccessful transmission, such as an indication that data is being retransmitted, wherein the unsuccessful indication is transmitted from either the node, or from neighboring nodes, to any other node. This allows the process to infer a successful transmission rate that is inversely proportional to the rate of retransmitted or otherwise unsuccessful packets.

In yet another embodiment, the process can estimate an effective throughput of the node and neighboring nodes, wherein the estimated effective throughput corresponds to a rate that data passes through the node and neighboring nodes. Counting indications of successful packet transmissions, or indications of unsuccessful packet transmissions, can be used to estimate effective throughput of the node and neighboring nodes, collectively. In alternative embodiments, specialized messages between nodes (e.g., reports of bit rates) can be used to produce a more accurate estimate of effective throughput of the node and neighboring nodes.

At 310, the process determines whether another CCA threshold may be needed. In one embodiment, the need for a new CCA threshold can be indicated by detecting a quality of service (QOS) degradation. For example, a QOS metric, such as a percentage difference between a desired data rate and an actual data rate, may be declining, which can indicate the need for a new CCA threshold. While the step shown at 310 may be optional, an advantage to having a triggering event for starting the CCA threshold adaptation process is that it can provide a limit to the number of nodes that are simultaneously adapting their CCA threshold. When more than one node simultaneously adapts its CCA threshold, subsequent measurements of rates of successful transmissions can be skewed because two or more nodes changed CCA thresholds at the same time.

As an alternative, the process can determine a new CCA threshold may be needed, or determine to test for a more effective CCA threshold, after a period of using the current CCA threshold. In yet another embodiment, the triggering event for automatically adjusting the CCA threshold can be the detection of a new node in the area, or detecting that a node has left the area.

If there is no triggering event for adjusting the CCA threshold (e.g., a degradation in the quality of service), the process continues using the current best CCA threshold while looping at the “No” branch of 308. If, however, the process detects a QOS degradation, or detects another event that triggers the determining of whether there is a more effective CCA threshold, the process selects a candidate CCA threshold from one of the possible CCA thresholds in the range, as illustrated at 312.

In one embodiment, a candidate CCA threshold can be selected based upon an expected change in busy activity level corresponding to a previously used CCA threshold. The busy activity level is a measurement of the percentage of time in which the channel is sensed busy by a node. The busy activity level varies with the CCA threshold used by a node because it relates to the number of nodes whose transmissions are sensed at a given CCA threshold. Current and historic data (e.g., measurements) can be stored in a table in data storage 126 (see FIG. 1), such as table 400 shown in FIG. 4, where possible CCA thresholds 402 have corresponding busy activity levels 404 that were measured when the CCA thresholds 402 were used in wireless device 102. The busy activity level is a ratio of the time the channel is declared busy to the time the channel is not busy, using a selected CCA threshold. The reason for considering the busy activity threshold is that it can be assumed that selecting a candidate CCA thresholds having similar busy activity level will not significantly improve a rate of successful transmissions among the node and neighboring nodes. Selecting a candidate CCA threshold associated with a significant difference in busy activity level speeds up the procedure of searching for a new CCA threshold.

A node can determine the busy activity level associated with all possible CCA thresholds 402 by using a series of digital averaging filters, one for each possible CCA threshold. Each digital averaging filter can have as an input signal a sequence of numbers valued 0 or 1, and can have as an output the busy activity level for its corresponding possible CCA threshold, which output is stored as busy activity level 404. Whenever the busy channel detector 128 senses the energy contained in the channel, the energy value is compared against each of the possible CCA thresholds 402. When comparing to a possible CCA threshold 402, if the energy sensed is below or above such threshold, a value 0 or 1 is input into the corresponding filter. Thus, when considering a candidate CCA threshold, if a first candidate CCA threshold has a similar busy activity level to a second candidate CCA threshold, then it is probable that the set of nodes present in the sensing region corresponding to the first candidate CCA threshold is similar to the set of nodes present in the sensing region corresponding to the second candidate CCA threshold.

Note that table 400 can also be used to store successful transmission rate measurements 406 that are associated with each CCA threshold 402. The successful transmission rate can be measured in terms of successful packets per second. These measurements 406 can be used when comparing the effects of using CCA thresholds 402. Additionally, column 408 can be used to store additional data associated with CCA thresholds 402, such as, for example, historical successful transmission rates, or averaged, filtered, or otherwise processed successful transmission rates. Such information can also be useful in selecting CCA candidates.

Next, the process determines a successful transmission rate in the node and neighboring nodes with the node using the candidate CCA threshold during a sample period, as illustrated at 314. This successful transmission rate can be determined in a manner similar to that used in 308, which, in one embodiment, uses counting indications of successful transmissions (e.g., counting ACK messages) during the sample period. Here again, the successful transmission rate measurement includes both the successful transmissions of the node and of neighboring nodes so as to measure the effect of changing the CCA threshold on a group of nodes in a manner that promotes fairness of access to the radio channel among the group.

Once a successful transmission rate for the candidate CCA threshold has been determined, the process determines whether the successful transmission rate increased when using the candidate CCA threshold compared to the current best CCA threshold, as depicted at 316. If the successful transmission rate increased, the process passes to 318 wherein the current best CCA threshold is replaced with the candidate CCA threshold, and the node begins using the newly replaced CCA threshold.

If, at 316, the successful transmission rate is not increased, or after the CCA threshold is replaced at 318, the process passes to 320, wherein process determines whether there are additional candidate CCA thresholds that should be tested. If there are additional candidate CCA thresholds, the process selects the next candidate CCA threshold at 322. This selection of the next candidate CCA threshold can be similar to the procedure used at 312.

If, at 320, there are no additional candidate CCA thresholds, and the process has cycled through all the candidates and selected the CCA threshold that produces a high rate of successful transmissions among the node and neighbor nodes, the process returns to 310 to await the next triggering event for adapting the CCA threshold.

The above described functions and structures can be implemented in one or more integrated circuits. For example, many or all of the functions can be implemented in the signal and data processing circuitry that is suggested by the block diagrams shown in FIG. 1. The program code suggested by the algorithm and processes of the flowchart of FIG. 4 can be stored in CCA threshold adapter 130 in program code 124, which are shown in FIG. 1.

The processes, apparatus, and systems, discussed above, and the inventive principles thereof are intended to produce an improved, more efficient, and more reliable distributed scheduling algorithm for scheduling data transmission, particularly in a single-channel single-transceiver MANET system. In general, the channel access procedures disclosed herein attempt to increase the system utilization by balancing the hidden-node and exposed-node problems. By periodically and automatically adapting the CCA threshold in response to a rate of successful transmissions among a node and its neighboring nodes, the overall throughput of the MANET can be increased. Nodes are able to self-configure their CCA threshold to a value closer to the best CCA threshold for the particular condition and location for the node. The approaches described herein can be implemented without changes to the IEEE 802.11 specification because there is no need for exchanging messages between nodes in order to measure the rate of successful transmissions. However, in alternative embodiments, such new messages can further improve the estimation of effective data throughput of the node and neighboring nodes, and can further coordinate the schedule upon which CCA thresholds are adapted in neighboring nodes. A single node in a wireless network can use the procedure described herein and the node and the network overall will benefit, even if other nodes do not use the procedure. The procedure described herein can be used in both pure ad hoc networks and mesh networks.

This disclosure is intended to explain how to fashion and use various embodiments in accordance with the invention, rather than to limit the true, intended, and fair scope and spirit thereof. The foregoing description is not intended to be exhaustive or to limit the invention to the precise form disclosed. Modifications or variations are possible in light of the above teachings. The embodiment(s) were chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A method for adapting a clear channel assessment (CCA) threshold in a node in a wireless network comprising:
determining a first successful transmission rate of the node and neighboring nodes in the wireless network, wherein the first successful transmission rate corresponds to the node being set to use a first CCA threshold;
determining a second successful transmission rate of the node and the neighboring nodes, wherein the second successful transmission rate corresponds to the node being set to use a second CCA threshold; and
selecting one of the first and the second CCA thresholds based upon the first and second successful transmission rates.

2. The method for adapting a CCA threshold according to claim 1 wherein the determining the first successful transmission rate and the determining the second successful transmission rate comprises:
determining the first successful transmission rate in response to using the first CCA threshold in the node to control access to the wireless network during a first period;
changing the first CCA threshold to the second CCA threshold; and
determining the second successful transmission rate in response to using the second CCA threshold in the node to control access to the wireless network during a second period.

3. The method for adapting a CCA threshold according to claim 1 wherein the neighboring nodes include a plurality of nodes in the wireless network from which the node can receive a transmission of a successful packet indication.

4. The method for adapting a CCA threshold according to claim 1 wherein the determining the first successful transmission rate of the node and the neighboring nodes comprises counting successful packet indications transmitted by the node and the neighboring nodes during the first period, and wherein the determining the second successful transmission rate of the node and the neighboring nodes comprises counting successful packet indications transmitted by the node and the neighboring nodes during the second period.

5. The method for adapting a CCA threshold according to claim 1 wherein the determining the first successful transmission rate of the node and neighboring nodes comprises determining a first rate of acknowledgement messages transmitted by the node and the neighboring nodes when the node CCA threshold is set to the first CCA threshold, and wherein the determining the second successful transmission rate of the node and neighboring nodes comprises determining a second rate of acknowledgement messages transmitted by the node and the neighboring nodes when the node CCA threshold is set to the second CCA threshold.

6. The method for adapting a CCA threshold according to claim 1 comprising selecting the second CCA threshold based upon a difference in a first busy activity level, measured in the node, that is associated with the first CCA threshold and a second busy activity level, measured in the node, that is associated with the second CCA threshold.

7. The method for adapting a CCA threshold according to claim 1 wherein the determining the second successful transmission rate comprises determining, in response to a degradation in quality of service, the second successful transmission rate of the node and the neighboring nodes, wherein the second successful transmission rate corresponds to the node being set to use the second CCA threshold.

8. The method for adapting a CCA threshold according to claim 1 further comprising delaying the determining the first and second successful transmission rates until detecting an event that triggers an automatic adaptation of the CCA threshold.

9. A method for packet transmission comprising:
using a first clear channel assessment (CCA) threshold in a node to control access to a channel in a wireless network for transmitting a first plurality of packets;
estimating a first effective throughput of the node and neighboring nodes as the node uses the first CCA threshold;
using a second CCA threshold in the node to control access to the channel in the wireless network for transmitting a second plurality of packets;
estimating a second effective throughput of the node and neighboring nodes as the node uses the second CCA threshold;
selecting a selected CCA threshold from the first and the second CCA thresholds based upon the first and second effective throughput estimates; and
using the selected CCA threshold in the node to control access to the channel in the wireless network for transmitting a third plurality of packets.

10. The method for packet transmission according to claim 9 wherein the estimating the first effective throughput of the node and neighboring nodes comprises counting indications of a successful packet transmission that are transmitted by the node and by neighboring nodes as the node uses the first CCA threshold, and wherein the estimating the second effective throughput of the node and neighboring nodes comprises counting the indications of a successful packet transmission that are transmitted by the node and by neighboring nodes as the node uses the second CCA threshold.

11. The method for packet transmission according to claim 9 wherein the estimating the first effective throughput of the node and neighboring nodes comprises determining a first rate of acknowledgement messages transmitted by the node and the neighboring nodes when the node CCA threshold is set to the first CCA threshold, and wherein the estimating the second effective throughput of the node and neighboring nodes comprises determining a second rate of acknowledgement messages transmitted by the node and the neighboring nodes when the node CCA threshold is set to the second CCA threshold.

12. The method for packet transmission according to claim 9 wherein the neighboring nodes comprise one or more nodes in the wireless network from which the node can receive an indication of a successful packet transmission.

13. The method for packet transmission according to claim 9 further including an event that triggers an automatic adaptation of the CCA threshold.

14. The method for packet transmission according to claim 13 wherein the delaying comprises delaying the using the second CCA threshold in the node until detecting a degradation in a quality of service.

15. A wireless device for transmitting packets in a wireless network comprising:
data memory for storing data and software code;
a transceiver;
a processor coupled to the data memory and the transceiver, wherein the processor, the transceiver, and the data memory are cooperatively operable to facilitate:
determining a first successful transmission rate of the wireless device and neighboring wireless devices in the wireless network, wherein the first successful transmission rate corresponds to the wireless device being set to use a first CCA threshold;
determining a second successful transmission rate of the wireless device and the neighboring wireless devices, wherein the second successful transmission rate corresponds to the wireless device being set to use a second CCA threshold; and
selecting one of the first and the second CCA thresholds based upon the first and second successful transmission rates.

16. The wireless device according to claim 15 wherein the processor, the transceiver, and the data memory are cooperatively operable to facilitate:
determining the first successful transmission rate in response to using the first CCA threshold in the wireless device to control access to the wireless network during a first period;
changing the first CCA threshold to the second CCA threshold; and
determining the second successful transmission rate in response to using the second CCA threshold in the wireless device to control access to the wireless network during a second period.

17. The wireless device according to claim 15 wherein the neighboring nodes include a plurality of nodes in the wireless network from which the node can receive a transmission of a successful packet indication.

18. The wireless device according to claim 16 wherein the processor, the transceiver, and the data memory are cooperatively operable to facilitate:
determining the first successful transmission rate of the node and neighboring nodes by counting successful packet indications transmitted by the node and the neighboring nodes during the first period; and
determining the second successful transmission rate of the node and neighboring nodes by counting successful packet indications transmitted by the node and the neighboring nodes during the second period.

19. The wireless device according to claim 16 wherein the processor, the transceiver, and the data memory are cooperatively operable to facilitate:
determining the first successful transmission rate of the node and neighboring nodes by determining a first rate of acknowledgement messages transmitted by the node and the neighboring nodes when the node CCA threshold is set to the first CCA threshold; and
determining the second successful transmission rate of the node and neighboring nodes by determining a second rate of acknowledgement messages transmitted by the node and the neighboring nodes when the node CCA threshold is set to the second CCA threshold.

20. The wireless device according to claim 15 wherein the processor, the transceiver, and the data memory are cooperatively operable to facilitate:
delaying the determining the second successful transmission rate until an event that triggers an automatic adaptation of the CCA threshold.
